(19) United States
(12) Patent Application Publication
(10) Pub. No.: US 2014/0161500 A1
(43) Pub. Date: Jun. 12, 2014

(54) FIXING APPARATUS

(71) Applicant: CANON KABUSHIKI KAISHA, Tokyo (JP)

(72) Inventors: Hiroshi Kataoka, Suntou-gun (JP); Tetsuya Sano, Mishima-shi (JP); Tomoaki Nakai, Numazu-shi (JP); Yusuke Jota, Suntou-gun (JP)

(73) Assignee: CANON KABUSHIKI KAISHA, Tokyo (JP)

(21) Appl. No.: 14/101,856

(22) Filed: Dec. 10, 2013

(30) Foreign Application Priority Data
Dec. 11, 2012 (JP) 2012-270303

(51) Int. Cl. G03G 15/20

(52) U.S. Cl. CPC G03G 15/2053
USPC 399/331

(57) ABSTRACT

A fixing apparatus for fixing a toner image on a recording material through a nip includes a sleeve; a nip forming member contacting an inner surface of the sleeve; a halogen heater provided in the sleeve; and a back-up member cooperating with the nip forming member to form the nip through the sleeve, wherein a surface of the nip forming member which contacts an inner surface of the sleeve is convex in a direction of approaching the back-up member, from each of opposite end portions thereof toward a central portion thereof with respect to a generatrix direction of the sleeve.

### FIELD OF THE INVENTION AND RELATED ART

The present invention relates to a fixing apparatus (device) which is mountable in an image forming apparatus such as an electrophotographic copying machine, an electrophotographic printer, and the like.

There have been known various types of fixing apparatus mountable in an electrophotographic copying machine or printer. One of such fixing apparatuses is of the so-called sleeve heating type, and is disclosed in Japanese Laid-open Patent Application 2009-93141. This type of fixing apparatus has a nip formation unit, and a fixation sleeve which rotates in contact with the nip formation unit. It has also a pressure roller which forms a nip between itself and fixation sleeve by being pressed against the nip formation unit with the placement of the fixation sleeve between itself and nip formation unit. Further, it has a halogen lamp which heats the fixation sleeve from the inward surface side of the fixation sleeve. In operation, a sheet of recording medium on which an unfixed toner image is present is conveyed through the nip of the fixing device while remaining pinched between the fixation sleeve and pressure roller and being subjected to the heat from the fixation sleeve. Consequently, the unfixed toner becomes fixed to the sheet of recording medium.

One of the effective methods for reducing in energy consumption, an electrophotographic image forming apparatus such as an electrophotographic copying machine, an electrophotographic printer, or the like, which is equipped with a fixing device of the so-called sleeve heating type, is to reduce in size its fixing device, which is the largest in power consumption among the various components of the image forming apparatus.

Reducing a fixing apparatus in size requires its nip formation unit, which is roughly in the form of a long and narrow rectangular parallelepiped, to be reduced in size. A fixing device of the so-called sleeve heating type, such as the one described above, is structured so that the lengthwise end portions of its nip formation unit are pressed against its pressure roller. Thus, reducing in size a fixing device of the so-called sleeve heating type is likely to cause the nip formation unit to deform in such a manner that the surface of the nip formation unit, which faces the pressure roller, gently bows in the opposite direction from the nip.

As the nip formation unit deforms as described above, the amount of pressure applied to the fixation sleeve by the lengthwise end portions of the nip formation unit becomes greater than the amount of force applied to the pressure roller by the lengthwise center portion of the nip formation unit. That is, the lengthwise end portions of the fixation roller are pressed against the pressure roller by the larger amount of pressure than the lengthwise center portion of the fixation sleeve. Consequently, the lengthwise end portions of the fixation sleeve becomes greater in peripheral velocity than the lengthwise center portion of the fixation sleeve, because the fixation sleeve is rotated by the rotation of the pressure roller. Thus, the fixation sleeve deforms in such a manner that the widthwise cross sectional area of the fixation sleeve becomes smallest at the lengthwise ends of the fixation sleeve, and gradually increases toward the lengthwise center. On the other hand, the halogen lamp is not subjected to an external force, except for its lengthwise end portions. Therefore, the distance between the inward surface of the fixation sleeve, and halogen lamp, becomes nonuniform in terms of the lengthwise direction of the fixation sleeve; it is smallest at the lengthwise ends of the fixation sleeve (halogen lamp) and gradually increases toward the center portion of the fixation sleeve (halogen lamp).

Therefore, the fixation sleeve becomes nonuniform in surface temperature; the surface temperature is highest at the lengthwise end portions, and gradually reduces toward the lengthwise center portion.

As the fixation sleeve of a fixing apparatus becomes nonuniform in temperature, the fixing device sometimes becomes unsatisfactory in fixation performance.

### SUMMARY OF THE INVENTION

Thus, the primary object of the present invention is to provide a fixing apparatus which has a halogen heater in the hollow of its fixation sleeve, and can prevent its fixation sleeve from becoming nonuniform in temperature in terms of the direction parallel to the generatrix of the fixation sleeve.

According to an aspect of the present invention, there is provided a fixing apparatus for fixing a toner image on a recording material by heating the recording material while feeding the recording material through a nip, said fixing device comprising a sleeve; a nip forming member contacting an inner surface of said sleeve; a halogen heater provided in said sleeve; and a back-up member cooperating with said nip forming member to form the nip through said sleeve, wherein a surface of said nip forming member which contacts an inner surface of said sleeve is convex in a direction of approaching said back-up member, from each of opposite end portions thereof toward a central portion thereof with respect to a generatrix direction of said sleeve.

According to another aspect of the present invention, there is provided a fixing apparatus for fixing a toner image on a recording material by heating the recording material while feeding the recording material through a nip, said fixing device comprising a sleeve; a nip forming member contacting an inner surface of said sleeve; a halogen heater provided in said sleeve; and a back-up member cooperating with said nip forming member to form the nip through said sleeve, wherein a surface of said nip forming member which contacts the inner surface of said sleeve is crowned toward said back-up member.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of a typical image forming apparatus to which the present invention is applicable, and shows the general structure of the apparatus.

FIG. 2A is a schematic sectional view of the fixing device in the first embodiment of the present invention, and shows the general structure of the device. FIG. 2B is a schematic external view of the fixing device in the first embodiment, as seen from the recording medium entrance side of the device.

FIG. 3A is a schematic external view of the main section of the fixing device in the first embodiment, as seen from the recording medium entrance side of the device. FIG. 3B is a drawing for showing the difference in position between the outward surface of the fixation sleeve when the fixation sleeve is not in the deformed state, and the outward surface of the fixation sleeve when the fixation sleeve is in the deformed state.

FIGS. 4A and 4B are drawings for illustrating the nip formation unit of the fixing device in the first embodiment; FIGS. 4A) and 4B are schematic sectional views of the nip formation unit, at vertical planes perpendicular to the widthwise and lengthwise directions of the unit, respectively.

FIGS. 5A and 5B are schematic sectional views of a conventional nip formation unit, at a vertical plane parallel to the widthwise direction of the unit.

FIG. 6 is a graph for describing the amount of the radiant energy loss which the inward surface of the fixation sleeve suffers as the fixation sleeve deforms in terms of the direction perpendicular to the lengthwise direction of the fixation sleeve.

FIG. 7 is a graph which shows the results of the measurement of the surface temperature of a fixing device equipped with the nip formation unit in the first embodiment, and the results of the measurement of the surface temperature of a fixing device equipped with the comparative nip formation unit.

FIG. 8 is an external view of the fixing device in the second embodiment of the present invention, as seen from the recording medium entrance side of the device.

FIG. 9 is a graph which shows the results of the measurement of the surface temperature of a fixing device equipped with the halogen lamp in the second embodiment, and the results of the measurement of the surface temperature of a fixing device equipped with the comparative halogen lamp.

FIG. 10 is a graph which shows the results of the measurement of the surface temperature of a fixing device equipped with the fixation sleeve in the third embodiment, and the results of the measurement of the surface temperature of a fixing device equipped with the comparative fixation sleeve.

FIG. 11 is a schematic sectional view of a fixing device which is different in the structure of the nip formation unit from the fixing devices in the preceding embodiments, and shows the general structure of the device.

### DESCRIPTION OF THE PREFERRED EMBODIMENTS

Hereinafter, the embodiments of the present invention are described in detail with reference to appended drawings.

### Embodiment 1

### (1) Image Forming Apparatus

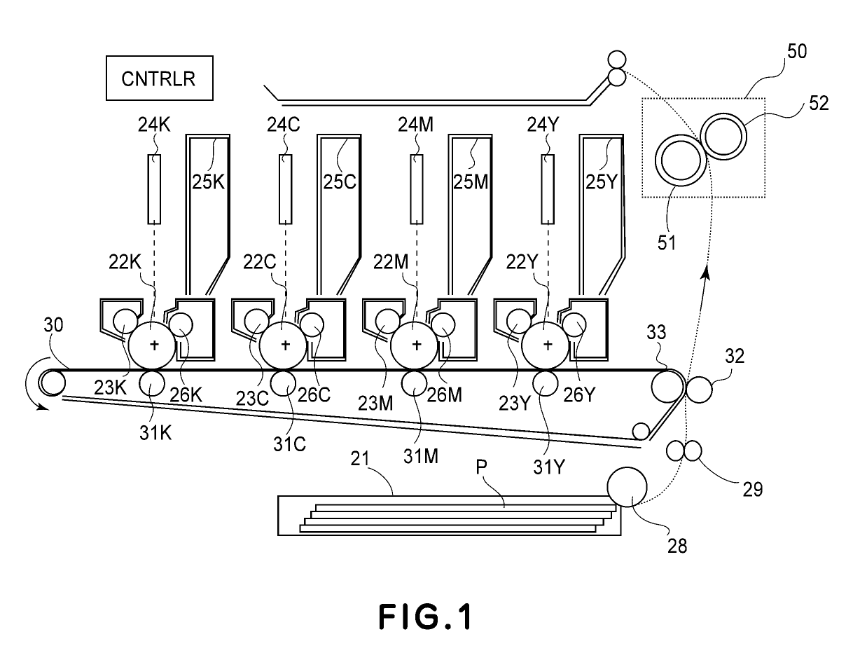

FIG. 1 is a schematic sectional view a typical image forming apparatus with which the present invention is compatible. It shows the general structure of the apparatus. This image forming apparatus is a full-color laser printer of the so-called inline type. It is capable of forming an image on a sheet of recording medium of A-4 size at a rate of 17 sheets (prints) per minute.

The image forming apparatus in this embodiment has: an image formation station SY which forms a yellow image; an image formation station MY which forms a magenta image; an image formation station CY which forms a cyan image; an image formation station KY which forms a black image; etc. These four image formation stations SY, MY, CY and KY are aligned in tandem, with preset intervals.

The image forming operation of the image forming apparatus in this embodiment is as follows: First, a motor (unshown) begins to be rotationally driven, in response to a print start command from an external apparatus (unshown) such as a host computer. Thus, the photosensitive drums (image bearing members) 22Y, 22M, 22C and 22K begin to rotate in the clockwise direction at a preset peripheral velocity (process speed). Further, the intermediary transfer belt 30 which is suspended, and kept tensioned, by the driver roller 33a, secondary transfer roller opposing roller 33b, and tension roller 33c, begins to be circularly moved in the counterclockwise direction at a preset peripheral velocity (process speed).

In image forming station SY, the charge roller 23 uniformly charges the peripheral surface of the photosensitive drum 22 to a preset polarity and a preset potential level (charging process). Then, the uniformly charged portion of the peripheral surface of the photosensitive drum 22 is scanned by (exposed to) a beam of laser light emitted from the exposing device (exposing process). Consequently, an electrostatic latent image is formed on the uniformly charged portion of the peripheral surface of the photosensitive drum 22. This electrostatic latent image is developed by the developing device 26 which uses yellow toner (developing process); a yellow toner image is formed on the peripheral surface of the photosensitive drum 22.

An image forming process, which is a combination of charging process, exposing process, and developing process, such as those described above, is carried out also in the image formation stations MY, CY and KY. Thus, magenta, cyan and black toner images are formed on the peripheral surfaces of the photosensitive drums 22 in the image formation stations MY, CY and KY, respectively. The developing devices 26 in the image formation stations SY, MY, CY and KY are supplied with yellow, magenta, cyan, and black toners from the toner cassettes 25Y, 26M, 26C and 26K, respectively.

The yellow toner image on the peripheral surface of the photosensitive drum 22 is transferred (primary transfer) onto the outward surface of the intermediary transfer belt 30, by a preset voltage applied to the primary transfer roller 31, in the primary transfer nip Tn1 formed between the peripheral surface of the photosensitive drum 22 and outward surface of the intermediary transfer belt 30. Similarly, the toner images, different in color, on the peripheral surface of photosensitive drums 22M, 22C and 22K, respectively, are transferred in layers onto the outward surface of the intermediary transfer belt 30 by preset voltages applied to the primary transfer rollers 31M, 31C and 31K, in the corresponding primary transfer nips Tn1, respectively. Consequently, an unfixed full-color toner image is effected on the intermediary transfer belt 30 by the four toner images, which are different in color.

Meanwhile, sheets P of recording medium stored in layers in the sheet feeder cassette 21 are fed one by one into the main assembly of the image forming apparatus while being separated from the rest in the cassette 21. Then, each sheet P of recording medium is sent to a pair of registration roller 29. Then, the registration rollers 29 send the sheet P to the secondary transfer nip Tn2 formed by the outward surface of the intermediary transfer belt 30 and the peripheral surface of secondary transfer roller 32. Then, the sheet P is conveyed through the secondary transfer nip Tn2 while remaining pinched between the outward surface of the intermediary transfer belt 30 and the peripheral surface of the secondary transfer roller 32. While the sheet P is conveyed through the secondary transfer nip Tn2, a preset voltage is applied to the secondary transfer roller 32. Thus, the unfixed full-color toner images effected by the four monochromatic toner images which are different in color is transferred onto the sheet P of recording medium (secondary transfer).

Then, the sheet P of recording medium, on which the unfixed full-color toner image is present, is introduced into a fixing device 50, and conveyed through the fixing device 50 while being subjected to heat and pressure. Consequently, the unfixed full-color toner image is fixed to the sheet P. After being conveyed out of the fixing device 50, the sheet P is conveyed further, and is discharged onto the delivery tray 61 by the pair of discharge rollers 60.

### (2) Fixing Device 50

In the following description of the embodiments of the present invention, the lengthwise direction of the fixing device 50, and also, the lengthwise direction of the structural components of the fixing device 50, mean the direction which is perpendicular to the recording medium conveyance direction of the fixing device 50. The widthwise direction of the fixing device 50, and also, the widthwise direction of the structural components of the fixing device 50, mean the direction parallel to the recording medium conveyance direction of the fixing device 50.

### (2-1) Structure of Fixing Device 50

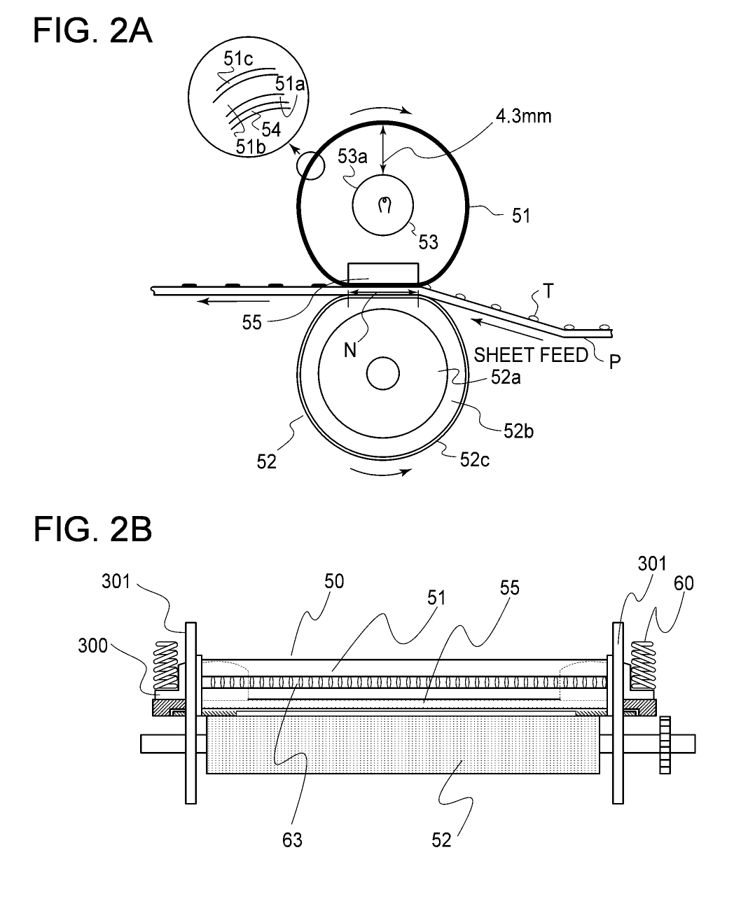

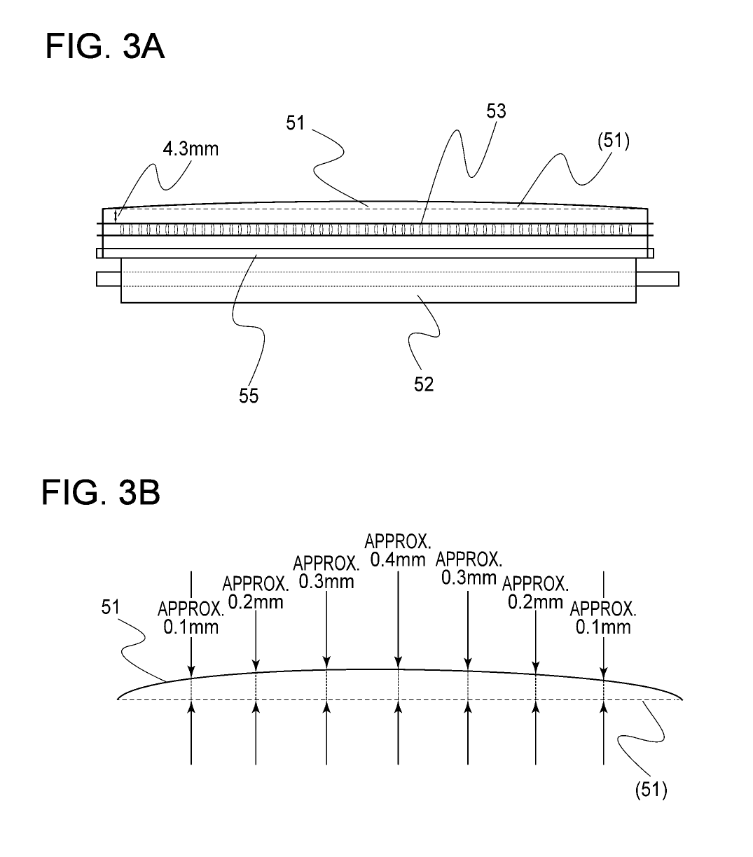

FIG. 2A is a schematic sectional view of the fixing device 50 in this embodiment, at a vertical plane parallel to the recording medium conveyance direction. It shows the general structure of the device 50. FIG. 2B is a plan view of the main portion of the fixing device 50 in this embodiment, as seen from the recording medium entrance side of the fixing device 50. It also shows the general structure of the main portion of the device 50. FIG. 3A is a plan view of the portion of the fixing device 50 in this embodiment, which is closely related to the present invention, as seen from the recording medium entrance side of the device 50. FIG. 3B is a drawing for showing the difference in position between the outward surface of the fixation sleeve when the fixation sleeve is not in the deformed state, and the outward surface of the fixation sleeve when the fixation sleeve is in the deformed state. In FIG. 3A, for the sake of the descriptive simplification, the contour of the deformed fixation sleeve 51 is represented by the solid line, whereas the contour of the fixation 51 in the normal condition is represented by the broken line. Further, a halogen lamp 53 in the fixation sleeve 51, and a nip formation unit 55, are contoured by the solid line.

The fixing device 50 in this embodiment is of the so-called sleeve heating type, which is very small in energy consumption, and also, very short in warm-up time. It employs a fixation sleeve 51, which is very thin, being therefor very small in thermal capacity. The fixation sleeve 51 is heated by radiant heat. More concretely, the fixing device 50 has the fixation sleeve 51 (cylindrical and rotational member), a pressure roller 52 (belt backing member), a nip formation unit 55 (nip forming member), a halogen lamp 53 (heat generating member), etc. The fixation sleeve 51, pressure roller 52, nip formation unit 55, and halogen lamp 53 are long and narrow members, the lengthwise direction of which is perpendicular to the recording medium conveyance direction of the fixing device 50.

The fixing device 50 is structured so that the nip formation unit 55 and halogen lamp 53 are disposed in the inward side of the cylindrical fixation sleeve 51, being positioned so that they oppose each other in terms of the radius direction of the fixation sleeve 51. As for the pressure roller 52, it is disposed so that it opposes the nip formation unit 55, which is on the inward side of the fixation sleeve 51, with the presence of the fixation sleeve 51 between the nip formation unit 55 and pressure roller 52.

Next, referring to FIG. 2B, the nip formation unit 55 is supported by the frame 301 of the fixing device 50; the lengthwise end portions of the nip formation unit 55 are supported by the frame 301, with the placement of a pair of supporting members 300 between them and frame 301, one for one. The halogen lamp 53 is supported by the nip formation unit supporting members 300 in such an attitude that it is parallel to the nip formation unit 55. It is supplied with electric power through a connector (unshown) which is electrically in connection to the electrically conductive portions of the halogen lamp 53. The pressure roller 52 is rotatably supported by its lengthwise end portions, by the frame 301; the lengthwise end portions of the shaft of the pressure roller 52 are supported by a pair of bearings (unshown), one for one, attached to the frame 301.

The pair of nip formation unit supporting members 300, which support the nip formation unit 55 by the lengthwise ends of the nip formation unit 55, one for one, are kept under the pressure generated by a pair of compression springs (pressing members) in the direction perpendicular to the generatrix of the pressure roller 52. Thus, the peripheral surface of the pressure roller 52 is kept pressed upon the peripheral surface of the fixation sleeve 51 by the pressure generated by the pair of compression springs, causing the elastic layer 52b (which will be described later) of the pressure roller 52 to elastically deform. Thus, a fixation nip N, which has a preset width, is formed between the peripheral surface of the fixation sleeve 51 and pressure roller 52.

### (2-2) Fixation Sleeve 51

The fixation sleeve 51 is a cylindrical member (endless member). It is made up of a cylindrical and thin substrate 51a, and the elastic layer 51b which covers virtually the entirety of the peripheral surface of the cylindrical substrate 51a. More concretely, the substrate 51a is formed of stainless steel plate (SUS-304S, or SUS-304L) which is 40 μm in thickness. The elastic layer 51b is formed of silicon rubber, and is roughly 300 μm in thickness. The fixation sleeve 51 has also a parting layer 51c, which covers the outward surface of the elastic layer 51b, being therefore the outermost layer of the fixation sleeve 51. The parting layer 51c is formed of fluorinated resin, and is 30 μm in thickness. The external diameter of the fixation sleeve 51 is roughly 21 mm.

The elastic layer 51b plays the role of storing the thermal energy for melting the unfixed toner image T on a sheet P of recording medium, and also, the role of keeping the toner (of which toner image T is formed) perfectly in contact with the surface of the sheet P, by conforming to the irregularities of the image bearing surface of the sheet P.

The parting layer 51c formed of fluorinated resin is a piece of tube formed of electrically nonconductive PFA (copolymer: tetrafluoroethylene-per-fluoroalkylvinylether). It is fitted around the combination of the substrate 51a and elastic layer 51b in such a manner that it covers virtually the entirety of the combination (peripheral surface of elastic layer 51b, in particular).

The inward surface of the fixation sleeve 51 is coated with heat resistant black paint (which hereafter may be referred to simply as black paint), which is a means for increasing the fixation sleeve 51 in the efficiency with which the fixation sleeve 51 absorbs the radiant heat from the halogen heater 53. As for the examples of the black paint 54, there is Okitsumo (registered commercial name). Further, Tetzsol (registered commercial name), “Thermoblack” (registered commercial name), etc, can be used in addition to Okitsumo. With the presence of the layer 54 of black paint on the inward surface of the fixation sleeve 51, the fixation sleeve 51 can efficiently absorb and store the radiant heat from the halogen lamp 53.

### (2-3) Pressure Roller 52

The pressure roller 52 has: a metallic core 52a; an elastic layer 52b which covers the entirety of the peripheral surface of the metallic core 52a, except for the lengthwise end portions of the core 52a; and a parting layer 52c which covers the entirety of the peripheral surface of the elastic layer 52b. The elastic layer 52b is roughly 3.5 mm in thickness, and is formed of electrically conductive silicon rubber (1×10⁴-1×10⁶Ω/□) in electrical resistance) by injection molding. The parting layer 52c, which is the outermost layer of the pressure roller 52, is roughly 40 μm in thickness, and is formed of fluorinated resin. It covers the entirety of the peripheral surface of elastic layer 52b.

The metallic core 52a is 13 mm in external diameter, and is made of free-cutting steel (SUM23, SUM 24, or the like). The fluorinated resin layer (parting layer) 52c is a piece of tube formed of electrically conductive PFA (copolymer: tetrafluoroethylene-perfluoroalkylbinylether), the electrical resistance of which is in a range of 1×10⁴-1×10⁷Ω/□, which is fitted around the combination of the metallic core 52a and elastic layer 52b to cover the entirety of the peripheral surface of the elastic layer 52b. The pressure roller 52 is roughly 20 mm in external diameter, and is roughly 56° (Asker-C hardness scale: 9.8 N load) in hardness.

The reason why electrically conductive PFA resin was used as the material for the parting layer 52c is as follows. Generally speaking, in the case of an electrophotographic printer which uses dry toner, “toner offset” is to be avoided. Thus, electrically conductive PFA resin was used to prevent the phenomenon that as the fixation sleeve 51 and pressure roller 52 rotate in contact with each other, the peripheral surface of the fixation sleeve 51 and the peripheral surface of the pressure roller 52 become charged. By the way, another means for preventing the “toner offset” is to make the fixation sleeve 51 and pressure roller 52 different in potential level.

In this embodiment, the parting layer 51c of the fixation sleeve 51 is a piece of tube formed of fluorinated resin, and fitted around the combination of the core and elastic layer of the sleeve 51, and the parting layer 52c of the pressure roller 52 is a piece of tube formed of fluorinated resin, and fitted around the combination of the core and elastic layer of the roller 52. However, the fluorinated layer may be formed by coating the peripheral surface of the sleeve 51 and roller 52 with fluorinated resin, and baking the coated fluorinated resin.

### (2-4) Nip Formation Unit 55

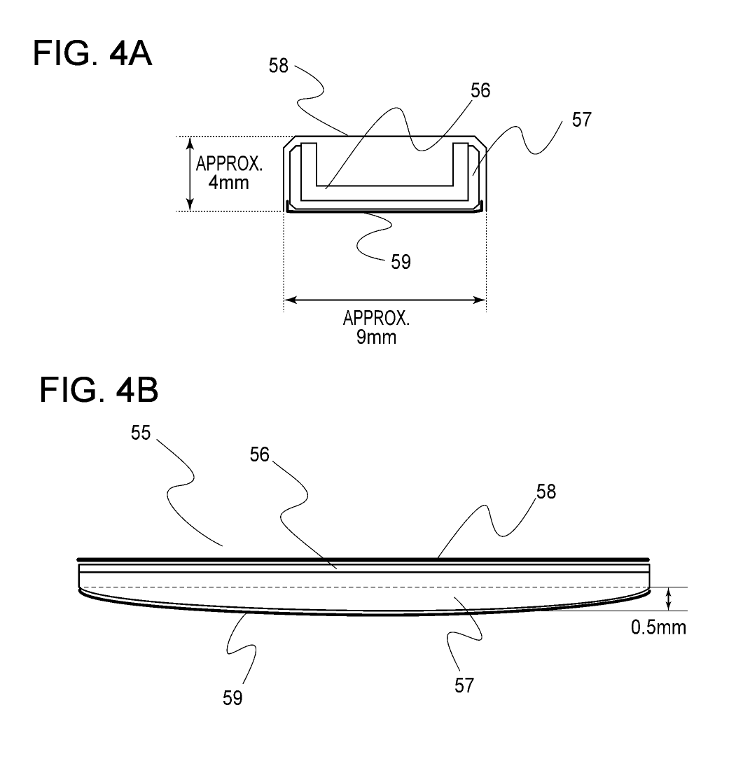

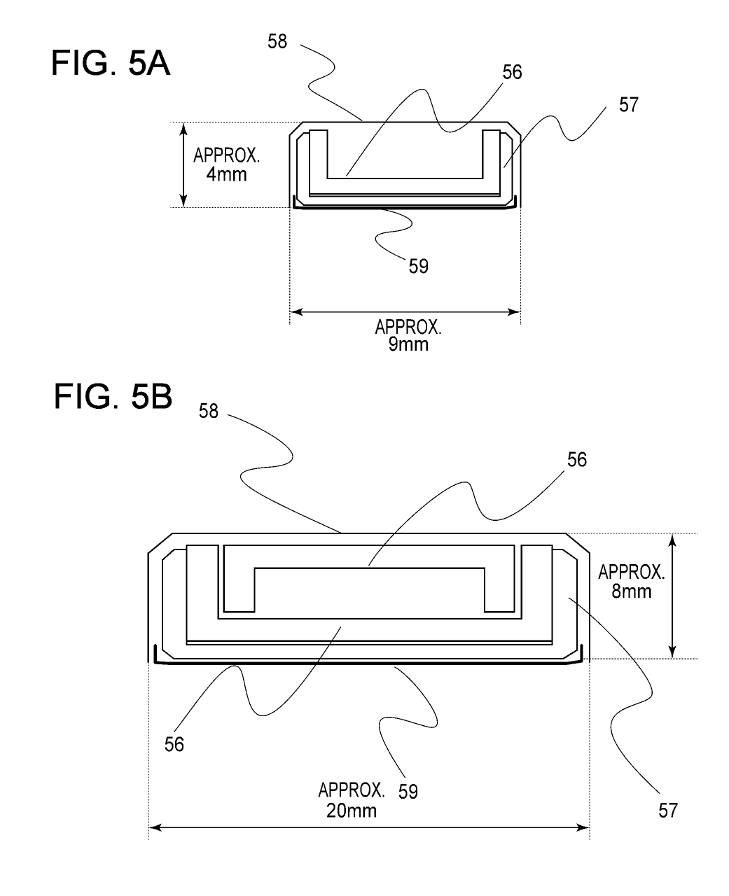

FIGS. 4A and 4B are drawings illustrating the nip formation unit 55. More specifically, FIG. 4A is a schematic sectional view of the nip formation unit 55, at a plane which is perpendicular to the lengthwise direction of the nip formation unit 55 and coincides with the center of the nip formation unit 55 in terms of the lengthwise direction. FIG. 4B is a schematic sectional view of the nip formation unit 55, at a plane which is parallel to the lengthwise direction of the nip formation unit 55 and coincides with the center of the nip formation unit 55 in terms of the widthwise direction of the nip formation unit 55. FIGS. 5A and 5B are schematic sectional views of an example of the conventional nip formation unit 55A, at a vertical plane which is perpendicular to the lengthwise direction of the unit 55A and coincides with the center of the unit 55 in terms of the lengthwise direction.

The nip formation unit 55 is roughly in the form of a long and narrow rectangular parallelepiped. It is rigid and heat resistant. It has to be rigid enough not to deform in the direction perpendicular to the lengthwise direction of the nip formation unit 55 even through the lengthwise end portions of the nip formation unit 55 are kept under the pressure from the pair of compression springs. Thus, its primary structural component is a stay 56 (reinforcement member), which is rigid enough to be unlikely to deform in the direction perpendicular to the lengthwise direction of the nip formation unit 55.

Since the stay 56 has to be rigid as described above, it is formed of steel, being therefore relatively large in thermal capacity. On the other hand, from the standpoint of energy consumption reduction, and quick start, the stay 56 has to be as small as possible in thermal capacity.

In this embodiment, therefore, the nip formation unit 55 is reduced as much as possible in size, in order to satisfy both the requirement that it has to be excellent in terms of rigidity, and also, the requirement that it has to be low in thermal capacity. More concretely, referring to FIG. 4A, the stay 56 is formed in such a shape that its cross section at a plane perpendicular to its lengthwise direction is roughly U-shaped. It is 1.4 mm in wall thickness. It makes up a part of the nip formation unit 55, which is roughly 9 mm in width and roughly 4 mm in height.

Referring to FIGS. 5A and 5B, a conventional nip formation unit 55A is roughly 20 mm in width and roughly 8 mm in height. That is, it is substantially larger than the nip formation unit 55 in this embodiment. It is made up of a stay 56A which is a combination of two pieces of steel components which are U-shaped in widthwise cross section. Thus, it is very rigid. Referring also to FIGS. 5A and 5B, a referential code 57A stands for a thermally insulating member, which corresponds in function to the thermally insulating member 57 in this embodiment. A referential code 58A is a reflective member, which corresponds in function to the reflective member 58 in this embodiment. A referential code 59A stands for a belt contacting member, which corresponds in function to the fixation film contacting member 59 in this embodiment.

The nip formation unit 55 (55A) is disposed inside the fixation sleeve 51. Thus, in the case of a fixing device having the conventional nip formation unit 55A which is substantially larger than the nip formation unit 55 in this embodiment, its fixation sleeve 51 also has to be substantially larger in external diameter. Thus, the fixation sleeve 51 used with the conventional nip formation unit 55A was roughly 30 mm, for example, in external diameter. Therefore, it is desired to be improved, from the standpoint of energy consumption reduction, and on-demand heating.

Further, in order for the thermal energy stored in the fixation sleeve 51, to be effectively utilized for fixing the unfixed toner image on a sheet P of recording medium, it is effective to transfer the thermal energy stored in the fixation sleeve 51, only to the sheet P. That is, it is not desired that heat conducts from the fixation sleeve 51 to the nip formation unit 55 (55A).

In comparison, in the case of the nip formation unit 55 in this embodiment, the thermally insulating member 57, which is made of a highly heat resistant resinous substance, such as liquid crystal polymer (OCP), which is thermally insulating and heat resistant, is placed between the fixation sleeve 51 and stay 56, to insulate between the fixation sleeve 51 and stay 56. Thus, the thermal energy stored in the fixation sleeve 51 conducts to only a sheet P of recording medium. That is, in this embodiment, the fixing device is reduced in electric power consumption, by increasing it in the efficiency with which thermal energy stored in the fixation sleeve 51 is used. The thermally insulating member 57 is U-shaped in widthwise cross section. It is formed of highly heat resistant material, and is roughly the same in thickness as the stay 56 (which is also U-shaped in widthwise cross section). Further, its size is such that it snugly cradles the stay 56 (FIG. 4A).

Further, in order to use the radiant thermal energy from the halogen lamp 53 as effectively as possible, the nip formation unit 55 is provided with a reflecting member 58 for reflecting the radiant heat from the halogen lamp 53 toward only the inward surface of the fixation sleeve 51. The reflecting member 58 is formed of a piece of reflective plate made of a preselected metallic substance which is heat resistant and thermally conductive. It is U-shaped in widthwise cross section, and can be fitted on the outward side of the aforementioned thermally insulating member 57, which is also U-shaped in widthwise cross section and fitted on the outward side of the stay 56. Further, the reflective member 58 is disposed on the outward side of the thermally insulating member 57, and covers the surface 56a of the stay 56, which is on the halogen lamp side, and also, covers the outward surface 57b of the thermally insulating member 57 in terms of the widthwise direction (FIG. 4A).

Further, the nip formation unit 55 is provided with a plate 59 for guiding the fixation sleeve 51 and minimizing the friction which occurs between the nip formation unit 55 and fixation sleeve 51 when the fixation sleeve 51 is rotated. The friction reducing plate 59 is positioned so that it faces the fixation sleeve 51. It is formed of a piece of preselected metallic substance which is very low in friction. It is U-shaped in its widthwise cross section, so that it can be fitted on the outward side the aforementioned thermally insulating member 57 which also is U-shaped in its widthwise cross section. Further, the friction reducing plate 59 is disposed between the thermally insulating member 57 and fixation sleeve 51, and covers the surface 57a of the thermally insulating member 57 (FIG. 4A). Incidentally, the thermally insulating member 57 itself may be utilized as a friction reducing member, instead of providing the nip formation unit 55 with the friction reducing plate 59.

In this embodiment, the fixation nip N which is necessary for fixing the unfixed toner image T on a sheet P of recording medium is roughly 7 mm in terms of its widthwise direction. It is formed by applying 160 N of pressure to the nip formation unit 55 to press the fixation sleeve 51 upon the pressure roller 52.

### (2-5) Halogen Lamp 53

The halogen lamp 53 used in this embodiment is such a halogen lamp that is made up of a halogen-filled piece of quartz glass tube 53a which is 7 mm in diameter, and a filament which is disposed in the halogen-filled hollow of the quartz glass tube 53a. It is 750 W in output (115 V in rated voltage). This halogen lamp 53 is supported by a supporting member, at roughly the center of the fixation sleeve 51 in terms of the widthwise cross section of the fixation sleeve 51 so that the radiant heat from the halogen lamp 53 is radiated upon the entirety of the inward surface of the fixation sleeve 51, except for the portion which is in contact with the nip formation unit 55. In terms of the lengthwise direction of the halogen lamp 53, the halogen lamp 53 is uniform in the amount of its heat generation per unit length. Referring to FIGS. 2A, 2B, and 3A, the distance between the peripheral surface (surface of halogen lamp 53) of the quartz glass tube 53a of the halogen lamp 53 and the inward surface of the fixation sleeve 51 is 4.3 mm.

### (3) Operation of Fixing Device 50

The fixing device 50 in this embodiment is structured so that the surface temperature of the lengthwise center portion of the fixation sleeve 51 is detected by its temperature detection element (temperature detecting member (unshown)), and the output signals of the temperature detection element are inputted into the temperature control section (unshown) made up of a CPU, and memories such as a ROM, a RAM, etc.

The temperature control section controls the power supply to the halogen lamp 53, according to the size and basis weight (thickness) of a sheet P of recording medium, as the sheet P is conveyed through (introduced into) the fixation nip N, so that the internal temperature of the fixation nip N remains at a proper level. For example, when a sheet P of ordinary paper, which is A4 in size and 80 g/m² in basis weight, is conveyed through the fixation nip N, the temperature control section controls the power supply to the halogen lamp 53 so that the temperature detected by the temperature detection element remains at a preset fixation level (target level). More concretely, in this embodiment, the temperature control section controls the power supply to the halogen lamp 53 so that the surface temperature of the fixation sleeve 51 remains at roughly 175° C.

The operation of the fixing device 50 in this embodiment is as follows. As the motor (unshown) begins to be rotationally driven in response to a print start command, the pressure roller 52 begins to be rotated by this motor in the direction indicated by an arrow mark (FIGS. 2A and 2B) at a preset peripheral velocity (process speed). The rotation of the pressure roller 52 is transmitted to the fixation sleeve 51 by the friction between the peripheral surface of the pressure roller 52 and the peripheral surface of the fixation sleeve 51, in the fixation nip N. Thus, the fixation sleeve 51 rotates, following the rotation of the pressure roller 52 and sliding on the friction reducing sheet 59 of the nip formation unit 55, by its inward surface.

Further, the power supply control circuit (unshown) is started up in response to the print start signal. As the power supply control circuit is started up, the halogen lamp 53 is supplied with electric power by an AC power source (unshown). Thus, the halogen lamp 53 irradiates radiant heat, heating thereby the inward surface of the fixation sleeve 51. The radiant heat from the halogen lamp 53 is absorbed by the fixation film 51 through the entirety of its inward surface coated with the black paint 54, except for the portion which is in contact with the nip formation unit 55. Thus, the fixation sleeve 51 quickly absorbs the radiant heat, stores the heat, and increases in temperature (surface temperature).

As the fixation sleeve 51 increases in temperature, its surface temperature is detected by the temperature detection element, and the output signals from the temperature detection element are picked up by the temperature control section, which determines, based on the output signals from the temperature detection element, proper values for the duty ratio, wave number, etc., for the voltage to be applied to the halogen lamp 53, so that the temperature of the inward surface of the fixation sleeve 51 remains at a preset fixation level (target level).

While the motor is rotationally driven, and the halogen lamp 53 is supplied with electric power, a sheet P of recording medium, on which an unfixed toner image T is present, is fed (introduced) into the fixation nip N, and is conveyed through the fixation nip N, remaining pinched between the peripheral surface of the fixation sleeve 51 and the peripheral surface of the pressure roller 52. While the sheet P is conveyed through the fixation nip N, the unfixed toner image T on the sheet P is heated by the fixation sleeve 51, being thereby melted, and is subjected to the internal pressure of the fixation nip N. Consequently, the unfixed toner image T on the sheet P becomes fixed to the surface of the sheet P. Then, the sheet P to which the unfixed toner image T has just been fixed, is separated from the peripheral surface of the fixation sleeve 51, and then, is discharged from the fixing device 50.

In this embodiment, the fixing device 50 was provided with only one fixation sleeve heating system having the halogen lamp 53 which is 750 W in output. However, this embodiment is not intended to limit the present invention in terms of the number of the halogen lamps to be employed to heat the fixation sleeve 51. For example, the present invention is also compatible with a fixing device provided with two fixation sleeve heating system having two halogen lamps (300 W and 450 W, one for one), which can be controlled independently or in combination to match the amount of radiant heat to be given to a sheet P of recording medium, to the size and basis weight of the sheet P.

### (4) Lengthwise Cross Sectional Shape of Nip Formation Unit 55

Next, the fixing device 50 in this embodiment is described about its characteristic features. This embodiment of the present invention is one of the concrete means for dealing with the problem stated in the above described section titled “Problem to Be Solved by the present invention”, that is, the nonuniformity in the temperature of the fixation sleeve 51, in terms of the lengthwise direction of the fixation sleeve 51, which is attributable to the deformation of the nip formation unit 55 in the height direction of the nip formation unit 55.

More concretely, the problem that as a fixing device is reduced in size, the nonuniformity in the surface temperature of the fixation sleeve 51 becomes conspicuous, is dealt with by forming the nip formation unit 55 in such a shape, in terms of the lengthwise cross section, that the surface of the nip formation unit 55, which directly faces the fixation sleeve 51 gently bows toward the fixation sleeve 51 in such a curvature that the lengthwise center of the fixation nip formation unit 55 is the highest point.

In this embodiment, the measured distance between the center of the opposite side of the peripheral surface of the fixation sleeve 51 from the fixation nip N, in terms of the diameter direction of the fixation sleeve 51, and the straight line between the corresponding lengthwise ends of the fixation sleeve 51 is roughly 0.4 mm (FIG. 3B). That is, the measured deformation of the fixation sleeve 51 at its lengthwise center is roughly 0.4 mm.

Referring to FIGS. 3A and 3B, the broken line (51) represents the contour of the fixation film 51 in its normal state (state of no deformation), and the solid line 51 represents the contour of the deformed fixation sleeve 51. Referring to FIG. 3B, the distance between the lengthwise center of the solid line 51 and the center of the broken line (51) is roughly 0.4 mm.

In this embodiment, the fixing device 50 is structured so that when the fixation sleeve 51 of the device 50 is not deformed, the device 50 is uniform in the distance between the surface of the halogen lamp 53 and the inward surface of the fixation sleeve 51, at roughly 0.4 mm. Thus, as the fixation sleeve 51 is deformed, the distance between the surface of the halogen lamp 53 and the lengthwise center of the inward surface of the fixation sleeve 51 can be estimated to be roughly 4.7 mm (=4.3+0.4).

Next, the radiant thermal energy (radiant energy, hereafter) of the halogen lamp 53 is described.

The amount of thermal energy, in the form of radiant heat, which a surface receives from a light source, is inversely proportional to the square of the distance between the surface and light source. Therefore, the amount of radiant energy which the lengthwise center of the inward surface of the fixation sleeve 51 receives from the halogen heater 53 when the distance between the lengthwise center of the inward surface of the fixation sleeve 51 and the surface of the halogen lamp 53 is roughly 4.7 mm is roughly 11% less than that which it receives when the distance is roughly 4.3 mm.

100−(((1/(0.0047×0.0047))/(1/(0.0043×0.0043))×100)=153(%).

Similarly, the amount of radiant energy, which three points of the inward surface of the fixation sleeve 51, the distance from which to the surface of the halogen lamp 53 is 0.1 mm, 0.2 mm and 0.3 mm, receive from the halogen lamp 53 are roughly 4.5%, 8.7% and 12.6%, respectively, less than that which the distance is roughly 4.3 mm.

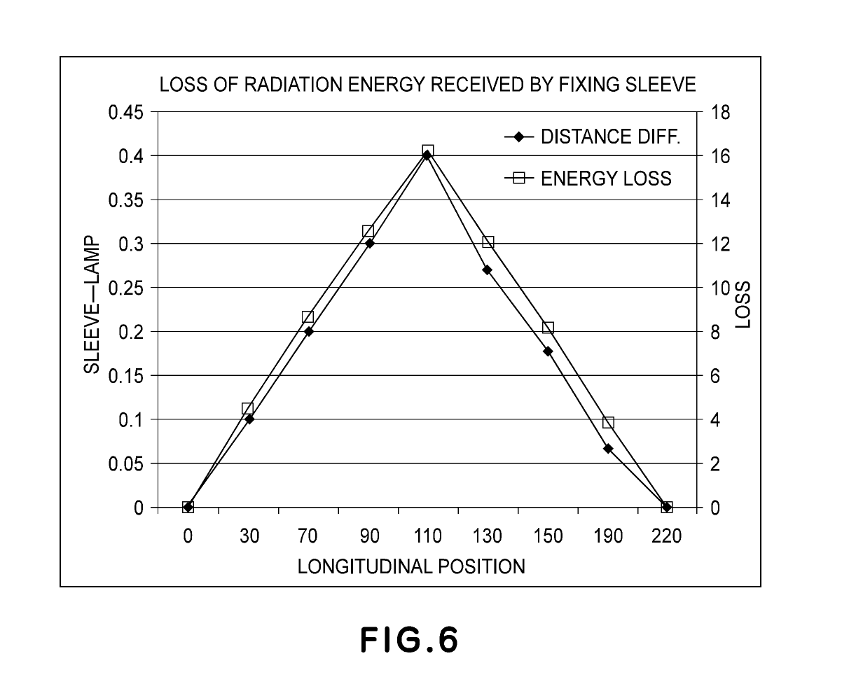

Shown in FIG. 6 is the relationship, in terms of the lengthwise direction of the fixation sleeve 51, between the loss in the amount of the radiant energy which the inward surface of the fixation sleeve 51 receives, and the distance between the inward surface of the fixation sleeve 51 and the surface of the halogen lamp 53.

In this embodiment, in order to compensate for the aforementioned 11% loss in the radiant energy, which makes the fixation sleeve 51 nonuniform in the surface temperature in terms of its lengthwise direction, the fixation sleeve 51 is utilized as the means for compensating for the deformation of the fixation sleeve 51 in the direction perpendicular to the lengthwise direction.

As described above, the deformation of the fixation sleeve 51 in the direction perpendicular to its lengthwise direction, which occurs as the preset amount of pressure is applied to the lengthwise end portions of the nip formation unit 55 to press the fixation sleeve 51 upon the pressure roller 52, is such deformation that, in terms of the radius direction of the fixation sleeve 51, the lengthwise center of the fixation sleeve 51 is roughly 0.4 mm offset outward relative to the lengthwise ends of the fixation sleeve 51.

In order to compensate for this deformation of the fixation sleeve 51, the nip formation unit 55 is designed so that its lengthwise cross section becomes as shown in FIG. 4B; the surface 55a of the nip formation unit 55, which contacts the inward surface of the fixation sleeve 51, becomes as shown in FIG. 4B. That is, the nip formation unit 55 is shaped so that, in terms of the lengthwise cross section of the nip formation unit 55, the surface of the nip formation unit 55, which contacts the inward surface of the fixation sleeve 51, gently bows toward the fixation sleeve 51.

More concretely, the thermally insulating member 57, which is one of the structural components of the fixation nip forming unit 55, is shaped so that its surface 57a, which faces the inward surface of the fixation sleeve 51, gently bows outward of the fixation nip formation unit 55 to make the lengthwise center portion of the thermally insulating member 57 thicker by roughly 0.5 mm than the lengthwise end portions of the thermally insulating member 57. Further, the friction reducing plate 56 is placed airtightly in contact with the surface 57a of the thermally insulating member 57 (shaped as described above), which faces the inward surface of the fixation sleeve 51, to make the above described surface 55a of the nip formation unit 55 gently bow outward of the nip formation unit 55.

Next, the results of the test carried out to verify the effectiveness of the above described nip formation unit 55 is described. In the test, the fixing device 50 equipped with the nip formation unit 55 in this embodiment was compared with a comparative fixing device, that is, a fixing device equipped with a comparative nip formation unit.

In the case of the comparative fixing device, the surface of the thermally insulating member, which faces the inward surface of the fixation sleeve 51, is flat in terms of the lengthwise direction of the fixing device. In the comparison test, the fixing device equipped with the comparative nip formation unit, and the fixing device equipped with the nip formation unit 55 in this embodiment, were mounted in a pair of printers which are the same in performance. Then, the two printers were evaluated for the under-fixation and over-fixation of the unfixed toner image on a sheet of recording medium. The under-fixation was evaluated in terms of level of fixation. The over-fixation was evaluated in terms of the amount of high temperature offset.

The performance of the fixing devices in terms of fixation was tested as follows. A halftone patch (image) was formed on a sheet of recording medium which is large (90 g/m²) in basis weight. Then, the resultant print was subjected to a scratch test. More specifically, the density of the halftone image was measured before and after it was scratched, and then, the density of the resultant image was enumerated. As for the evaluation of high temperature offset, halftone images formed on a sheet of recording medium which is small (60 g/m²) were subjected to sensory tests.

The results of the evaluation are given in Table 1.

TABLE 1
Longitudinal shape of a surface of the insulating member
in nip (N) side of fixing nip

| | | Comprison Example | |
|---|---|---|---|
| This Embodiment | | Flat | |
| Smooth convex | | Fixing | |
| Fixing property (%) | High temp. offset | property | High temp offset |
| 6-10 (◯) | ◯ | 16-20 (▴) | ◯ |

In Table 1;
“◯”: in fixation column stands for “excellent” in that scratching did not disturb images at all,
“▴”: in fixation column stands for “unsatisfactory” in that effects of scratching were recognizable,
“◯”: in high temperature offset column stands for “excellent” in that there was no sign of high temperature offset.

As is evident from Table 1, in the case of the fixing device equipped with the comparative nip formation unit, unsatisfactory fixation attributable to the deformation of the lengthwise end portion of the fixation sleeve in the radial direction of the fixation sleeve, was recognizable.

In comparison, in the case of the fixing device 50 equipped with the nip formation unit 55 in this embodiment, it was possible to compensate for the deformation of the fixation sleeve 51 attributable to the reduction in size of the fixing device, which was stated in the preceding section titled “Problem to Be Solved by Present Invention”. That is, the fixing device 50 in this embodiment was stable in fixation performance.

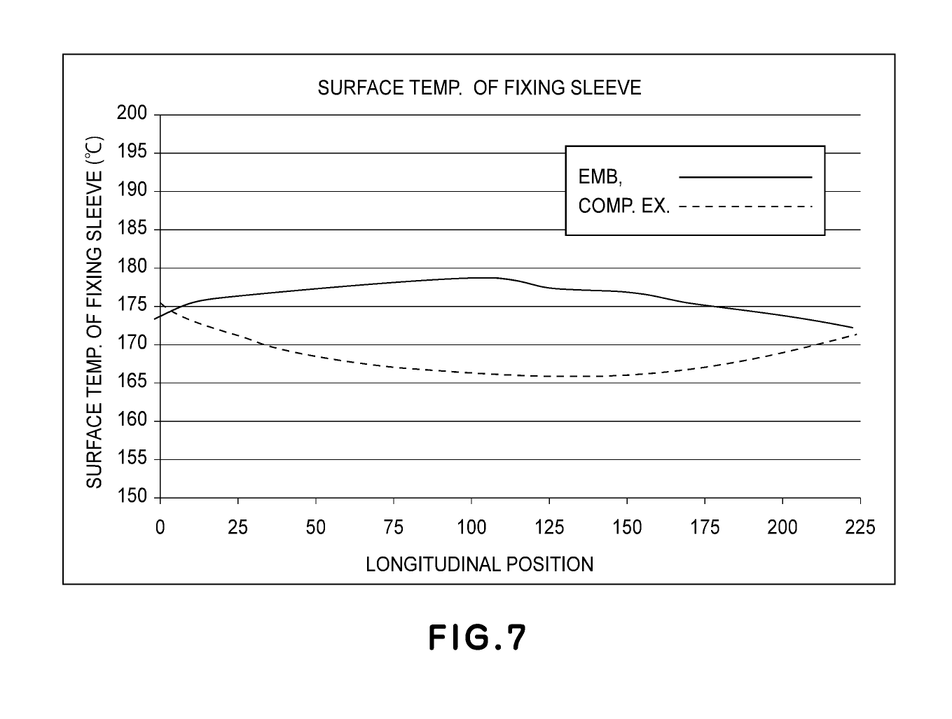

Shown in FIG. 7 are the results of the measurement of the surface temperature of the fixation sleeve 51 of the fixing device 50 equipped with the nip formation unit 55 in this embodiment, the test results of which are shown in Table 1, and those of the fixing device equipped with the comparative nip formation unit, the test results of which are shown also in Table 1. More concretely, the surface temperature of the fixation sleeve of each of the two fixing devices was measured with the use of an infrared thermograph apparatus (Thermotracer TH9100: product of NEC Co., Ltd).

The axis of abscissas of the graph in FIG. 7 stands for a given point of the fixation sleeve 51 in terms of the lengthwise direction of the fixation sleeve 51, and the axis of ordinates stands for the surface temperature of the fixation sleeve 51.

Both the fixing device equipped with the nip formation unit 51 in this embodiment, and the fixing device equipped with the comparative nip formation unit, were controlled so that when a sheet of recording medium which is A4 in size was used as recording medium, the surface temperature of their fixation sleeve was maintained at 175° C. Thus, the surface temperature of the fixation sleeve of each of the two fixing device remained at roughly 175° C.

Referring to FIG. 7, in the case of the comparative fixing device, it was observed that the temperature distribution of the peripheral surface of the fixation sleeve in terms of the lengthwise direction is such that the surface temperature is highest at the lengthwise ends and gradually reduces toward the center portion, to roughly 165° C., creating temperature difference between the lengthwise end portions and center portion as indicated by the broken line in FIG. 7. The comparative fixing device was below the satisfactory level in terms of fixation performance. This phenomenon indicates that the surface temperature distribution of a fixation sleeve is related to the above described fixation performance of the fixing device. That is, this phenomenon is attributable to the deformation of the fixation sleeve.

In comparison, in the case of the fixing device 50 in this embodiment, the phenomenon that the fixation sleeve 51 drops in surface temperature across its lengthwise center portion was prevented. That is, the lengthwise center portion of the fixation sleeve 51 remained at roughly 175° C. as indicated by the solid line in FIG. 7. Therefore, the fixing device 50 remained satisfactory in fixation performance as is evident from the test results in Table 1.

As described above, the fixing device 51 in this embodiment can compensate, by its nip formation unit 55 itself, the deformation of the nip formation unit 55, which occurred as the fixing device 51 was reduced in size to reduce the fixing device in energy consumption. In other words, the fixing device 51 in this embodiment can prevent the fixation film 51 from being deformed in the direction perpendicular to the lengthwise direction of the fixation film 51. Therefore, it does not become nonuniform in surface temperature in terms of its lengthwise direction. That is, this embodiment can make a fixing device stable in fixation performance.

### Embodiment 2

Next, the fixing device 50 in the second embodiment of the present invention is described about its characteristic features.

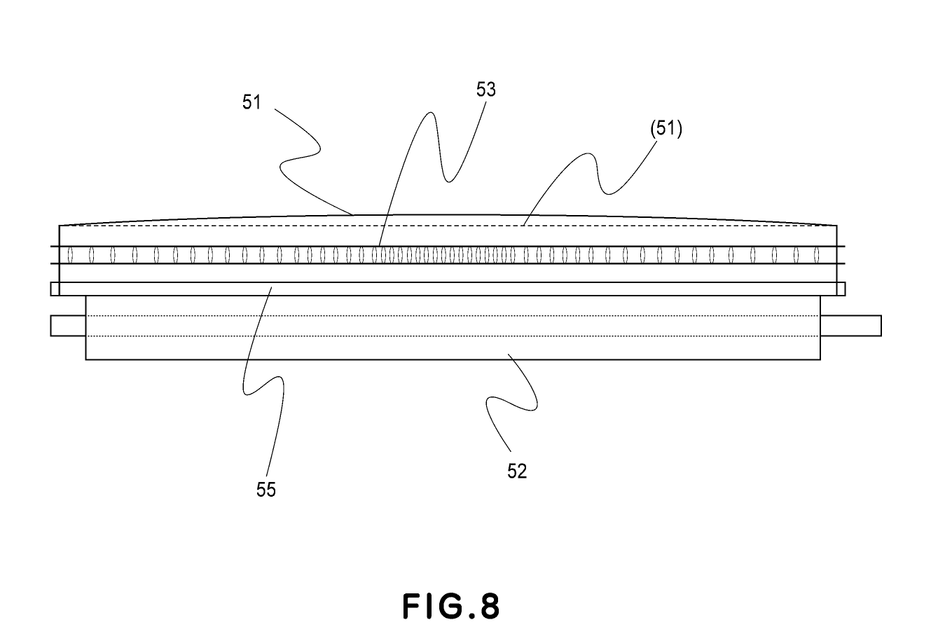

FIG. 8 is a schematic external view of the fixing device 50 in this embodiment, as seen from the recording medium entrance side of the device 50. In FIG. 8, a solid line and a broken line are used to show the contour of the deformed fixation sleeve 51, and that of the normal fixation sleeve 51 (before it is deformed), respectively. Further, the halogen lamp 53 which is in the hollow of the fixation sleeve 51, and the nip formation unit 55, are also contoured with solid line.

This embodiment of the present invention is such an embodiment that can provide a means for solving the problem that reducing a fixing device in size makes the fixation sleeve of the device nonuniform in its temperature in the lengthwise direction of the fixation sleeve, as described in the preceding section titled “Problem to Be Solved by Present Invention”.

More concretely, in order to solve the problem that reducing a fixing device in size makes the fixing sleeve of the device nonuniform in heat distribution in its lengthwise direction, the halogen lamp 53 in the first embodiment was replaced with a halogen lamp designed so that the amount of its heat generation is lowest at the lengthwise ends, and gradually increases toward the lengthwise center portion.

In order to modify the halogen lamp 53 so that the amount by which a given point of the halogen 53 generates heat gradually increases from the lengthwise ends toward the lengthwise center portion, the halogen lamp 53 was modified in structure as follows. Referring to FIG. 8, the halogen lamp 53 is designed so that the pitch with which the filament 53f of the halogen heater 53 is wound per unit length in the lengthwise direction of the halogen lamp 53 gradually increases from the lengthwise ends toward the lengthwise center portion of the lamp 53. Thus, the halogen lamp 53 in this embodiment is such that the lengthwise center portion of the halogen lamp 53 is greater in the amount of heat generation than the lengthwise end portions.

As stated in the above given description of the first embodiment, the amount by which a given surface receives radiant heat as radiant energy from a given heat source is inversely proportional to the square of the distance between the surface and heat source. Thus, in order to compensate a given point of the fixation sleeve for this thermal loss, the halogen lamp 53 in this embodiment is structured as follows. In order to make the halogen lamp 53 proper in surface temperature distribution in terms of the lengthwise direction of the halogen lamp 53, more concretely, in order to make the lengthwise center portion of the halogen lamp 53 roughly 16% greater in the amount of heat generation than the lengthwise end portions of the halogen lamp 53, the filament 53f of the halogen lamp 53 gradually increases in the pitch with which it is wound from the lengthwise ends toward the lengthwise center portions as is schematically shown in FIG. 8.

Next, the results of the test carried out to verify the effectiveness of the above described halogen lamp 53 is described. In the test, the fixing device 50 equipped with the halogen lamp 53 in this embodiment was compared with a comparative fixing device, that is, a fixing device equipped with a comparative halogen lamp.

The comparative halogen lamp was uniform in the amount of heat generation per unit length in terms of its lengthwise direction. In the comparison test, the fixing device equipped with the comparative halogen lamp, and the fixing device equipped with the halogen lamp 53 in this embodiment, were mounted in a pair of printers which are the same in performance. Then, the two printers were evaluated for the under-fixation and over-fixation of the unfixed toner image on a sheet of recording medium. The under-fixation was evaluated in terms of the satisfactoriness of the fixed toner image, and the over-fixation was evaluated in terms of the amount of high temperature offset.

The results of the evaluation are given in Table 2. The meaning of the referential codes in Table 2 are the same as those in Table 1.

TABLE 2
Heat generation distribution of halogen lamp

| | | Comprison Example | |
|---|---|---|---|
| This Embodiment | | | High |
| Fixing property (%) | High temp. offset | Fixing property | temp offset |
| 7-10 (◯) | ◯ | 13-19 (▴) | ◯ |

As is evident from Table 2, in a case where the comparative halogen lamp was employed by a fixing device reduced in size for the reduction in energy consumption, the fixing device reduced in fixation performance. In comparison, in a case where the halogen lamp 53 in this embodiment was employed by a fixing device reduced in size for the reduction of energy consumption, the thermal loss attributable to the deformation of the fixation sleeve 51 was compensated for. That is, this embodiment (halogen lamp 53) can stabilize a fixing device in performance.

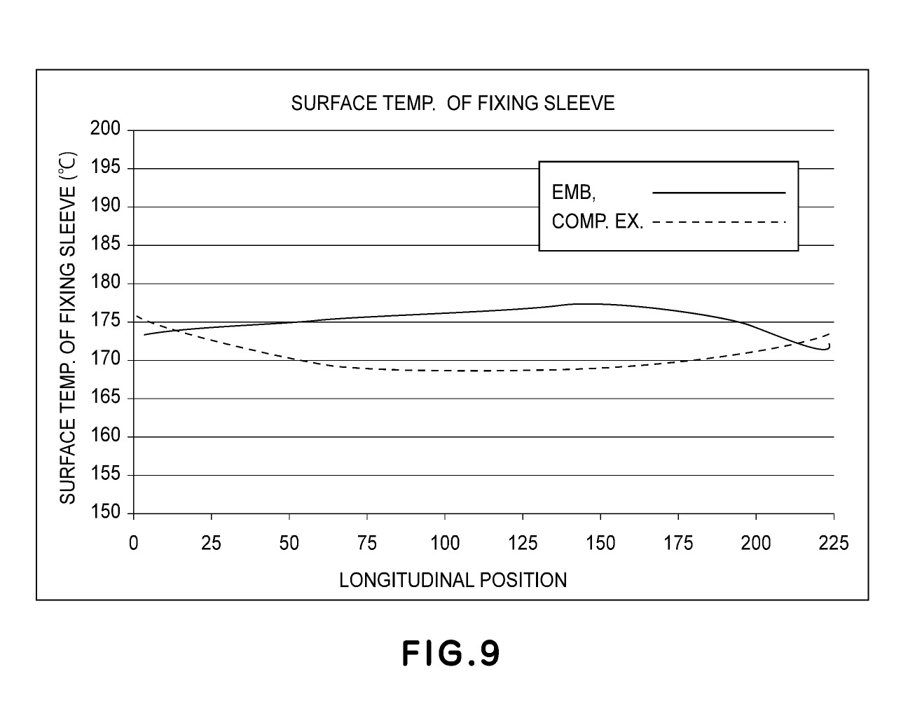

Shown in FIG. 9 are the results of the measurement of the surface temperature of the fixation sleeve 51 of the fixing device 50 equipped with the halogen lamp 53 in this embodiment, the performance of which is shown in Table 2, and those of the fixing device equipped with the comparative halogen lamp. More concretely, the surface temperature of the fixation sleeve of each of the two fixing devices was measured with the use of an infrared thermograph apparatus (Thermotracer TH9100: product of NEC Co., Ltd).

The axis of abscissas of the graph in FIG. 9 stands for a given point of the fixation sleeve 51 in terms of the lengthwise direction of the fixation sleeve 51, and the axis of ordinates stands for the surface temperature of the fixation sleeve 51.

Both the fixing device equipped with the halogen lamp 53 in this embodiment, and the fixing device equipped with the comparative halogen lamp were controlled so that when a sheet of recording medium which is A4 in size was used as recording medium, the surface temperature of their fixation sleeve is maintained at 175° C. Thus, the surface temperature of the fixation sleeve of each of the two fixing devices remained at roughly 175° C.

Referring to FIG. 9, in the case of the comparative fixing device, it was observed that the temperature distribution of the peripheral surface of the fixation sleeve in terms of the lengthwise direction was such that the surface temperature was highest at the lengthwise ends and gradually reduces toward the center portion, to roughly 168° C., creating temperature difference between the lengthwise end portions and center portion as indicated by the broken line in FIG. 9. The comparative fixing device was below the satisfactory level in terms of fixation performance. This phenomenon indicates that the surface temperature distribution of a fixation sleeve is related to the above described fixation performance of the fixing device. That is, this phenomenon is attributable to the failure of the comparative halogen lamp to compensate for the deformation of the fixation sleeve.

In comparison, in the case of the fixing device 50 in this embodiment, the phenomenon that the fixation sleeve 51 drops in surface temperature across its lengthwise center portion was prevented. That is, the lengthwise center portion of the fixation sleeve 51 remained at roughly 175° C. as indicated by the solid line in FIG. 9. Therefore, the fixing device 50 remains satisfactory in fixation performance as is deducible from Table 2 which shows the results of the test.

As described above, the fixing device 50 in this embodiment can compensate for the thermal loss attributable to the deformation of the fixation sleeve 51, which results as an attempt is made to reduce the fixing device in size, with the use of its halogen lamp 63. That is, the halogen lamp in this embodiment can compensate for the nonuniformity in surface temperature of the fixation sleeve in terms of the lengthwise direction of the fixation sleeve, and therefore, can keep the fixing device stable in fixation performance.

### Embodiment 4

Next, the characteristic features of the fixing device 50 in this embodiment are described.

In this embodiment, this embodiment is another embodiment of the means for solving the problem related to the nonuniformity in the temperature of the fixing sleeve 51 in terms of its lengthwise direction, which is attributable to the deformation of the fixation sleeve 51 in the direction perpendicular to its lengthwise direction, which tends to occur as a fixing device 50 is reduced in size, as described in the preceding section titled “Problem to Be Solved by Present Invention”.

As the fixing sleeve 51 deforms in the direction perpendicular to its lengthwise direction, the distance between the surface of the halogen lamp 53 and the inward surface of the fixation sleeve 51 becomes nonuniform in terms of the lengthwise direction of the halogen lamp 53 and fixation sleeve 51, as stated in the description of the first embodiment. In this embodiment, therefore, in order to compensate for the nonuniformity in the distance between the surface of the halogen lamp 53 and inward surface of the fixation sleeve 51, a fixation sleeve 51, which is nonuniform in heat absorption efficiency in terms of its lengthwise direction in such a manner that its heat absorption efficiency is lowest at its lengthwise ends, and gradually increases toward the lengthwise center portion, was used in place of the fixation sleeve 51 in the first embodiment. More concretely, in order to prevent the fixation film 51 from becoming nonuniform in temperature in terms of its lengthwise direction, the inward surface of the fixation sleeve 51 was coated with the black paint 54 in such a manner that the coated layer of the black paint 54 on the inward surface of the fixation sleeve 51 was thinnest at the lengthwise ends of the fixation sleeve 51 and gradually increases in thickness toward the center portion of the fixation sleeve 51.

Next, the results of the test carried out to verify the effectiveness of this embodiment are described. In the test, a fixing device equipped with the comparative fixation sleeve, and a fixing device equipped with the fixation sleeve 51 in this embodiment, were compared.

The comparative fixation sleeve is such a fixation sleeve that the layer of the black paint coated on the inward surface of the fixation sleeve is uniform in thickness in terms of the lengthwise direction of the fixation sleeve, being in a range of 1.2-1.4.

In comparison, the fixation film 51 in this embodiment was such a fixation sleeve that is nonuniform in the thickness of the layer of black paint coated on the inward surface of the fixation sleeve 51. More specifically, it is such a fixation sleeve that the layer of black point 54 coated on its inward surface thinnest at its lengthwise ends, at which its thickness is in a range of 0.7-0.9, and gradually increase in thickness toward its lengthwise center portion, at which its thickness is in a range of 1.3-1.4, in order to make the inward surface of the fixation sleeve 51 nonuniform in heat absorption efficiency in terms of its lengthwise direction.

The color density of the layer of the black paint was measured with a color density meter. More concretely, it was measured with a spectroscopic color density meter X-Rite 504 (product of X-light Co., Ltd.).

In the comparison test, a pair of printers which are the same in performance were equipped with a fixing device equipped with the comparative fixation sleeve, and a fixing device equipped with the fixation sleeve 51 in this embodiment, one for one, and were evaluated for the under-fixation and over-fixation of an unfixed toner image on a sheet of recording medium. The contents of the evaluation are the same as those of the fixing device in the first embodiment.

The results of the tests are given in Table 3. The meaning of the referential codes in Table 3 are the same as those of the referential codes in Table 1. A referential code “X” means that scratch marks were clearly recognizable, indicating that the fixing device was unsatisfactory in fixation.

TABLE 3
Black paint distribution on the inner peripheral surface of the fixing sleeve

| This Embodiment | | Comprison Example | |
|---|---|---|---|
| Smooth convex | | Flat | |
| Fixing property | | Fixing property | |
| (%) | High temp. offset | (%) | High temp offset |
| 6-10 (◯) | ◯ | 17-23 (X) | ◯ |

Reducing a fixing device in size causes the fixation sleeve of the fixing device to deform. In a case where the comparative fixation sleeve is employed by a small fixing device, it reduces the fixing device in fixation performance. In comparison, the fixation sleeve 51 in this embodiment can compensate for the thermal loss attributable to the deformation of the fixation sleeve 51. As is evident from Table 3, the fixation sleeve 51 in this embodiment can provide the fixing device with satisfactory fixation performance.

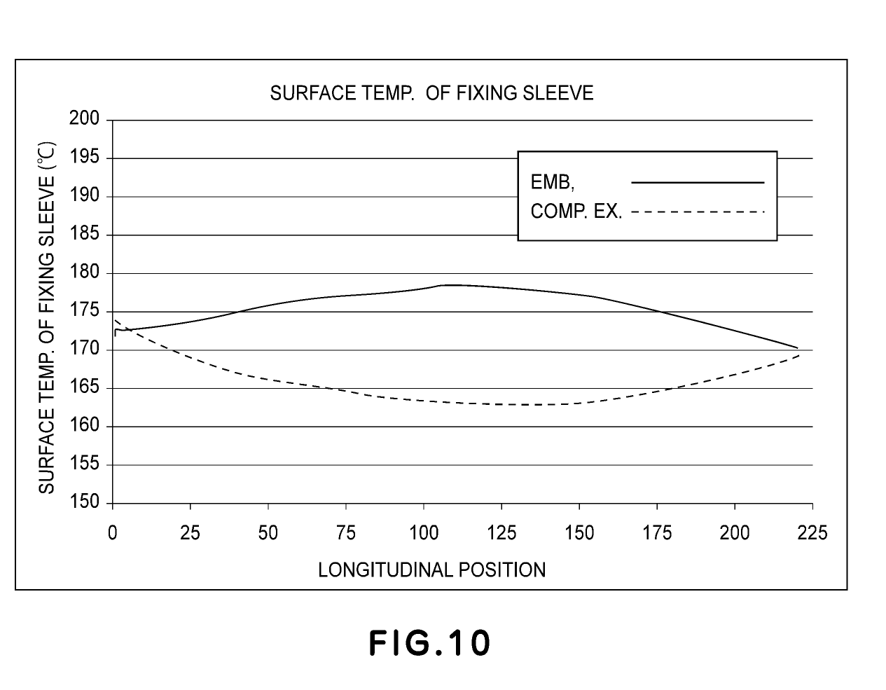

Shown in FIG. 10 are the results of the measurement of the surface temperature of the fixation sleeve 51 employed by a fixing device 50, and the surface temperature of the comparative fixation sleeve employed by another fixing device 50 which is identical to the fixing device 50 by which the fixation sleeve in this embodiment was employed, except for the fixation sleeve. The surface temperature of the fixation sleeve of each fixing device was measured with infrared thermograph apparatus (Thermotracer TH 9100: product of NEC Co., Ltd.).

The axis of abscissas of the graph in FIG. 10 stands for a given point of the fixation sleeve 51 in terms of the lengthwise direction of the fixation sleeve 51, and the axis of ordinates stands for the surface temperature of the fixation sleeve 51.

Both the fixing device equipped with the fixation sleeve 51 in this embodiment, and the fixing device equipped with the comparative fixation sleeve were controlled so that when a sheet of recording medium which is A4 in size was used as recording medium, the surface temperature of their fixation sleeve is maintained at 175° C. Thus, the surface temperature of the fixation sleeve of each of the two fixing devices remained at roughly 175° C.

Referring to FIG. 10, in the case of the comparative fixing device, it was observed that the temperature distribution of the peripheral surface of the fixation sleeve in terms of the lengthwise direction was such that the surface temperature was highest at the lengthwise ends and gradually reduced toward the center portion, reducing to roughly 163° C., creating temperature difference between the lengthwise end portions and center portion as indicated by the broken line in FIG. 10. The comparative fixing device was below the satisfactory level in terms of fixation performance. This phenomenon indicates that the surface temperature distribution of a fixation sleeve is related to the above described fixation performance of the fixing device. That is, this phenomenon is attributable to the failure of the comparative fixation sleeve to compensate for the deformation of the fixation sleeve.

In comparison, in the case of the fixing device 50 in this embodiment, the phenomenon that the fixation sleeve 51 drops in surface temperature across its lengthwise center portion was prevented. More concretely, the temperature of the lengthwise center portion of the fixation sleeve 51 remained at roughly 175° C. as indicated by the solid line in FIG. 10. That is, the fixing device 50 in this embodiment remained satisfactory in fixation performance as is deducible from Table 3 which shows the results of the test.

As described above, the fixing device 50 in this embodiment can compensate for the thermal loss attributable to the deformation of the fixation sleeve 51, which results as an attempt is made to reduce the fixing device in size, with the use of its fixation sleeve 51. That is, the fixation sleeve 51 in this embodiment can prevent the problem that the deformation of the fixation sleeve of a fixing device reduces the fixing device in fixation performance. In other words, the fixation sleeve in this embodiment is stable in fixation performance at an excellent level.

### [Miscellanies]

As will be evident from the above given description of the first to third embodiments of the present invention, the problem related to the nonuniformity in the surface temperature of the fixation sleeve 51 in terms of the lengthwise direction of the fixation sleeve 51 can be solved by the modification of each of the nip formation unit 55, halogen lamp 53, and fixation sleeve 51 itself. However, the modified versions of the nip formation unit 55, halogen lamp 53, and fixation sleeve 51 may be employed in the combination of two or more, as desired. The effects of such employment are the same as those described above.

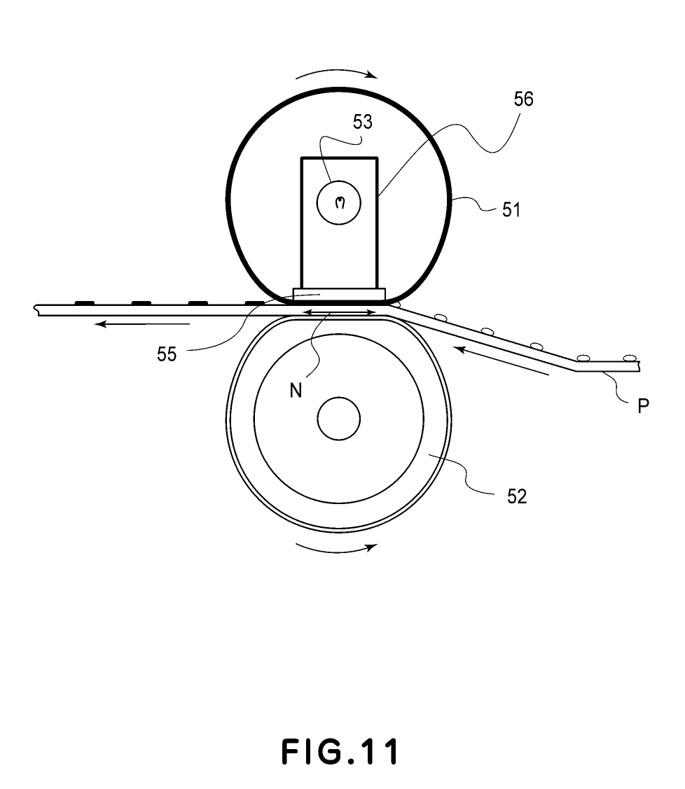

Further, referring to FIG. 11, the fixing device 50 may be structured so that a reinforcement member 56, which is U-shaped in its widthwise cross-section, is disposed so that its open end faces toward the fixation nip to make the radiant heat from the halogen heater 53 heat primarily the nip portion. In this case, the edges of the friction reducing member 57, which face the inward surface of the fixation sleeve 51, are to be contoured so that, their distance to the pressure roller is largest at their lengthwise ends, in terms of the direction parallel to the generatrix of the fixation sleeve 51, and gradually reduces toward their center portion. The effects of this structural arrangement are the same as those described above.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 270303/2012 filed Dec. 11, 2012 which is hereby incorporated by reference.

What is claimed is:

1. A fixing apparatus for fixing a toner image on a recording material by heating the recording material while feeding the recording material through a nip, said fixing device comprising:
a sleeve;
a nip forming member contacting an inner surface of said sleeve;
a halogen heater provided in said sleeve; and
a back-up member cooperating with said nip forming member to form the nip through said sleeve,
wherein a surface of said nip forming member which contacts an inner surface of said sleeve is convex in a direction of approaching said back-up member, from each of opposite end portions thereof toward a central portion thereof with respect to a generatrix direction of said sleeve.

2. The apparatus according to claim 1, wherein said nip forming member includes a metal plate, a resin material sliding member provided between the metal plate and said sleeve, said sliding member has a thickness increasing from each of the opposite end portions of said sleeve toward the central portion in the generatrix direction.

3. The apparatus according to claim 2, wherein the plate is U-shaped which opens away from the nip.

4. The apparatus according to claim 2, wherein the plate is U-shaped which opens toward the nip.

5. The apparatus according to claim 1, further comprising supporting members provided at opposite end portions of said nip forming member, respectively, and said nip forming member is urged to said back-up member through said supporting members, and wherein said halogen heater is supported by said supporting member at opposite end portions thereof.

6. The apparatus according to claim 1,
wherein said nip forming member is provided with a reflection plate in a side opposing said halogen heater.

7. A fixing apparatus for fixing a toner image on a recording material by heating the recording material while feeding the recording material through a nip, said fixing device comprising:
a sleeve;
a nip forming member contacting an inner surface of said sleeve;
a halogen heater provided in said sleeve; and
a back-up member cooperating with said nip forming member to form the nip through said sleeve,
wherein a surface of said nip forming member which contacts the inner surface of said sleeve is crowned toward said back-up member.
